(19) United States
(12) Patent Application Publication
(10) Pub. No.: US 2024/0402586 A1
(43) Pub. Date: Dec. 5, 2024

(54) ACOUSTIC CAMERA INCLUDING EXPLOSION PROOF MEANS OR WATERPROOF MEANS

(71) Applicant: SM INSTRUMENTS CO., LTD, Daejeon (KR)

(72) Inventor: Young-Key KIM, Daejeon (KR)

(73) Assignee: SM INSTRUMENTS CO., LTD, Daejeon (KR)

(21) Appl. No.: 18/697,468

(22) PCT Filed: Oct. 20, 2022
(86) PCT No.: PCT/KR2022/016091

§ 371 Date: Mar. 31, 2024

(30) Foreign Application Priority Data
Oct. 21, 2021 (KR) 10-2021-0140720

(51) Int. Cl. G03B 42/06; G03B 17/08

(52) U.S. Cl. CPC G03B 42/06; G03B 17/08

(57) ABSTRACT

An acoustic camera including an explosion proof means, according to one embodiment of the present invention, comprises: acoustic sensors (M) for sensing sound waves; a sensor substrate (20) on which the acoustic sensors (M) are mounted; a photographing means (30); a housing (40) in which a main control unit (50) is embedded; and the main control unit (50) for receiving and processing an acoustic signal (a pulse density module (PDM) signal). An acoustic camera including a waterproof means, according to one embodiment of the present invention, comprises: a front body (10); acoustic sensors (M) for sensing sound waves or ultrasonic waves; a sensor substrate (20) on which the acoustic sensors (M) are mounted; a photographing means (30); a housing (40) covering the rear of the front body (10); and a waterproof means (90) for preventing water from reaching the acoustic sensors (M) or the sensor substrate (20).

### TECHNICAL FIELD

The present invention relates to an acoustic camera equipped with explosion-proof means or waterproof means.

### BACKGROUND ART

Registered Patent No. 10-1471299 (patent holder: SM Instrument Co., Ltd., Hyundai Motor Co., Ltd.) is composed of a front body in which a sound detecting parts of the sound sensors are arranged to face forward; sound sensors with a sound detecting part exposed to the front body while fixed to a substrate; a substrate on which sound sensors are mounted; an image capture unit in which a capture lens is exposed through a lens hole in the front body; a rear body surrounding the rear side of the substrate and the rear side of the image capture unit with the substrate positioned on the rear side of the front body; The front body includes a planar anterior plate. Disclosed is a mobile acoustic camera wherein the front plate and the substrate are arranged in parallel.

Since the microphone mounted on the board in an array form must detect sound through an acoustic detection hole, it must be exposed to the air environment to be detected from the perspective of air transmission. At this time, the microphone and microphone connection circuit are both contacted and exposed to the air environment to be detected. If an acoustic camera is installed in an ignitable gas environment with a high risk of explosion, there may be a risk of explosion due to the acoustic camera's power, electronic circuit, etc.

Registered Patent No. 10-1213540 (patent holder: SM Instruments Co., Ltd.) discloses an acoustic camera using an acoustic sensor array, characterized in that it includes a sound detection device that is mounted on a circuit board (Print Circuit Board, 20) and transmits signals related to the detected sound to the data collecting unit and a display unit connected to the sound detection device, connected to a data collecting unit that samples the analog signal about the sound transmitted from the sound detection device, converts it into a digital signal about the sound, and transmits it to the central processing unit, connected to a central processing unit that calculates each acoustic sensor and the associated noise level based on the digital signal about the sound transmitted from the data collecting unit and displaying the noise level related to each acoustic sensor calculated by the central processing unit in color. In the case of an acoustic camera, a groove is formed in front of the sensor because the acoustic sensor must be exposed to the air.

Registered Patent No. 10-1471299 (Patent Holder: SM Instrument Co., Ltd., Hyundai Motor Co., Ltd.) includes front body in which the acoustic detection part of the acoustic sensors is arranged to face forward; acoustic sensors whose acoustic detection part is exposed to the front body when fixed to the sensor board; sensor board on which acoustic sensors are mounted; video recording unit where the recording lens is exposed through the lens hole in the front body; and with the sensor board located on the rear side of the front body, the rear body surrounds the back of the sensor board and the rear of the image capture unit. The anterior body includes a planar anterior plate. Disclosed is a mobile acoustic camera characterized in that the front plate and the sensor board are arranged in parallel.

### DISCLOSURE

### Technical Problem

The present invention is to provide an acoustic camera having an explosion-proof structure that limits electrical energy to prevent ignition in a hazardous atmosphere by electric sparks, arcs, or high temperatures generated when the acoustic camera is normal or malfunctioning (disconnection, short circuit, etc.).

In addition, the present invention is intended to provide an acoustic camera having a pressure-resistant explosion-proof structure in which the effects of an explosion (ignition factor) inside the acoustic camera housing are not transmitted to the air or ignitable gas outside the housing.

In addition, the present invention is intended to provide an acoustic camera with excellent acoustic detection performance and a waterproof function so that it can be installed or portably used in outdoor places rather than indoors.

### Technical Solution

The acoustic camera equipped with the explosion-proof means of the present invention includes acoustic sensors (M) that detect sound waves or ultrasonic waves introduced through the sound wave induction grooves (21), a sensor board (20) on which the acoustic sensors (M) are mounted, a housing (40) located behind the sensor board (20) and forming a built-in space (Room), and a main control (50) that receives and processes sound signals generated by the acoustic sensors (M). The main control (50) is located in the built-in space (Room) inside the housing (40), and the sensor board (20) is located outside the housing (40).

The acoustic camera equipped with the explosion-proof means of this invention further includes a barrier circuit unit (60) installed between the acoustic sensors (M) and the main control unit (50), the barrier circuit unit (60) transmits the acoustic signal generated by the acoustic sensor (M) to the main control unit (50), the barrier circuit unit (60) suppresses the increase in current or voltage on the acoustic sensor (M) and the acoustic signal transmission line, and the barrier circuit unit (60) and the main control unit (50) are located in the interior room of the housing (40).

In the acoustic camera equipped with the explosion-proof means of the present invention, a data collection unit FPGA (61) is further provided between the sensor board (20) and the main control unit (50), and the barrier circuit unit (60) is provided between the sensor board (20) and the data collection unit (FPGA, 61).

The acoustic camera provided with the explosion-proof means of the present invention may further include a photographing means 30 for photographing a scene in which the sensor board 20 is facing as an image.

In the acoustic camera equipped with the explosion-proof means of this invention, the barrier circuit unit (60) includes a resistance (60a) for suppressing current rise and a Zener diode (60c) for suppressing voltage rise and a fuse (60b) for blocking overcurrent on the acoustic signal transmission line (PL) or the clock signal (CLK) that transmits the pulse density module signal (PDM) generated by the acoustic sensor (M).

In the acoustic camera equipped with the explosion-proof means of the present invention, the barrier circuit unit 60 is connected to the acoustic signal common transmission line PL_common via the first acoustic signal transmission line PL_sub1, the second acoustic sensor M2 is connected to the acoustic signal common transmission line PL_common via the second acoustic signal transmission line PL_sub2, and the first acoustic sensor M1 is connected to the acoustic signal common transmission line CL_common via the first clock signal transmission line CL_sub1, and the second acoustic sensor M2 is connected to the clock signal common transmission line CL_common via the second clock signal transmission line CL_sub2.

The acoustic signal common transmission line (PL_common) includes a resistance installation unit (PL_common 1) with a resistance 60a to suppress current rise, an electronic device installation unit (PL_common 2) with a Zener diode (60c) to suppress voltage rise, and a fuse installation unit (PL_common 3) with fuses (use, 60b) for blocking overcurrent.

The acoustic sensors M mounted on the sensor board 40 are disposed to have a separation distance of 1.5 mm or more from each other.

The distance between the acoustic signal transmission line PL and the clock signal transmission line CL is preferably 1.5 mm or more, and the separation distance between one acoustic signal common transmission line PL_common and the other acoustic signal common transmission line CL_common is preferably 1.5 mm or more.

A separation distance between any one of a plurality of fuses 60b and the other fuse may be preferably 10 mm or more.

In an acoustic camera equipped with an explosion-proof means of the present invention, the housing 40 includes a front partition wall portion 41 located behind the sensor board 20, the housing 40 includes a rear wall portion 42, a side wall portion 43, and a front partition wall portion 41 forming a room blocked from the outside, and the sensor board 20 equipped with the acoustic sensor M is preferably located in front of the front partition portion 41 outside the housing 40.

The acoustic camera equipped with the explosion-proof means of this invention preferably includes a front body (10) equipped with multiple sound wave inflow holes (11) that induce sound waves or ultrasonic waves to reach the acoustic sensor (M).

In the acoustic camera equipped with the explosion-proof means of the present invention, it is preferable that the front partition wall 41 includes an imaging hole 41a, the imaging hole 41a is closed with a transparent tempered glass 35, and the imaging means 30 is located behind the tempered glass 35 and in the interior space room of the housing 40.

The acoustic camera equipped with the waterproof means of the present invention includes a front body 10 equipped with the sound wave inflow holes 11, acoustic sensors (M) that detect sound waves or ultrasonic waves entering through the sound wave inflow holes 11 or sound wave induction grooves 21, a sensor board 20 equipped with sound sensors (M), a photographing means 30 that captures the scene where the front body 10 is facing, a housing 40 that covers the rear of the front body 10, and a waterproof means part 90 that prevents water from reaching the acoustic sensor (M) or sensor board 20 through the sound wave inflow hole 11.

In the acoustic camera equipped with the waterproof means of the present invention, the waterproof means part 90 includes a sound wave-permeable waterproof membrane 91 that shields the sound wave inflow hole 11 in the transverse direction to prevent water from penetrating. The position of the sound wave-permeable waterproof membrane 91 is characterized by being provided between the front surface of the front body 10, the middle point of the sound wave inflow hole 11 (the point between the front end and the rear end of the sound inflow hole 11), or between the rear surface of the front body 10 and the front surface of the sensor board 20.

In the acoustic camera equipped with the waterproof means of this invention, the sound wave inflow hole (11) is characterized in that the width or diameter of the front side (exposed side) is larger than the width or diameter of the rear side (substrate side) and the cross-sectional area continuously increases from the rear side (substrate side) to the front side (exposed side).

In the acoustic camera equipped with the waterproof means of the present invention, the waterproof means part 90 consists of a sound wave-permeable waterproof membrane 91 that horizontally shields the sound wave inflow hole 11, a first adhesive layer 92 located on the rear surface of the front body 10 or the front surface of the sound wave-permeable waterproof membrane 91, and a compressible sponge layer 94 attached to the opposite side of the first adhesive layer and pressed (pressurized) in contact with the front of the sensor board 20.

The acoustic camera equipped with the waterproof means of this invention is characterized in that a counter bore 96 formed to be stepped from the rear of the front body 10 is further formed in the sound wave inflow hole 11, the waterproof means part 90 is placed in the counter bore 96, and the first adhesive layer 92 is in contact with the bottom surface of the counter bore 96.

In the acoustic camera equipped with the waterproof means of the present invention, the thickness of the sound-transmitting waterproof membrane 91 of the waterproof means part 90 is 0.005 to 0.02 mm.

In the acoustic camera equipped with the waterproof means of the present invention, the waterproof means part 90 is located on the rear side (opposite side of the first adhesive layer 92) of the sponge layer 94 and further includes a second adhesive layer 95 attached to the front of the sensor board 20.

In the acoustic camera equipped with the waterproof means of the present invention, the depth of the counter bore 96 is 0.2 to 2 mm.

The acoustic camera equipped with the waterproof means of the present invention is characterized in that it further includes an upper protruding cover part 12 fixed to the upper part of the front body 10 or the housing 40 and protruding further forward than the front surface of the front body 10.

### Advantageous Effects

According to the present invention, an acoustic camera having an explosion-proof structure that limits electrical energy to prevent ignition in a hazardous atmosphere by electric sparks, arcs, or high temperatures generated when the acoustic camera is normal or malfunctions (disconnection, short circuit, etc.) is provided.

In addition, according to the present invention, an acoustic camera having a pressure-resistant explosion-proof structure is provided in which the influence of an explosion (ignition factor) inside the acoustic camera housing is not transmitted to the air or ignitable gas outside the housing.

In addition, according to the present invention, an acoustic camera with excellent acoustic detection performance and a waterproof function is provided so that it can be installed or portably used in outdoor places rather than indoors.

### DESCRIPTION OF DRAWINGS

FIG. 1 is an overall configuration diagram of an acoustic camera equipped with an explosion-proof means or a waterproof means according to an embodiment of the present invention.

FIG. 2 is a partial configuration diagram of an acoustic camera equipped with explosion-proof means or waterproof means according to an embodiment of the present invention.

FIG. 3 is a cross-sectional view of an acoustic camera equipped with explosion-proof means according to an embodiment of the present invention.

FIG. 4a is a plan view of the first barrier PCB area of the barrier circuit unit according to an embodiment of the present invention.

FIG. 4b is a bottom view of the first barrier PCB area of the barrier circuit unit according to an embodiment of the present invention.

FIG. 5a is a plan view of the second barrier PCB area of the barrier circuit unit according to an embodiment of the present invention.

FIG. 5b is a bottom view of the second barrier PCB area of the barrier circuit unit according to an embodiment of the present invention.

FIG. 6 is a detailed diagram of a barrier circuit according to an embodiment of the present invention.

FIG. 7 is a detailed view of the separation distance of the barrier circuit unit according to an embodiment of the present invention.

FIG. 8a is a bottom perspective view of an acoustic camera equipped with explosion-proof means according to an embodiment of the present invention.

FIG. 8b is an external front view of an acoustic camera equipped with explosion-proof means according to an embodiment of the present invention.

FIG. 8c is an external rear view of an acoustic camera equipped with explosion-proof means according to an embodiment of the present invention.

FIG. 9a is a cross-sectional view of epoxy molding according to an embodiment of the present invention.

FIG. 9b is a detailed cross-sectional view of epoxy molding according to an embodiment of the present invention.

FIG. 9c is a detailed cross-sectional view showing the configuration of a pin header of epoxy molding according to an embodiment of the present invention.

FIG. 10 is a detailed view of a substrate for a sensor according to an embodiment of the present invention.

FIG. 11 (a, b, c, d) is a detailed view of the front body according to an embodiment of the present invention.

FIG. 12 is an external view of an acoustic camera equipped with an explosion-proof means or a waterproof means according to an embodiment of the present invention.

FIG. 13 is a conceptual diagram of an acoustic camera equipped with explosion-proof means according to an embodiment of the present invention.

FIG. 14 is a gas ignition curve for explaining the effect of an acoustic camera equipped with explosion-proof means according to an embodiment of the present invention.

FIG. 15a is a performance result diagram (power waveform) of an acoustic camera to which the barrier circuit of FIG. 6 of the present invention is applied.

FIG. 15b is an acoustic camera performance result (PDM, acoustic signal waveform) to which the barrier circuit of FIG. 6 of the present invention is applied.

FIG. 16a is an acoustic camera performance result (clock signal waveform) to which the barrier circuit unit of FIG. 6 of the present invention is applied.

FIG. 16b is an acoustic camera performance result (acoustic signal FFT waveform) to which the barrier circuit of FIG. 6 of the present invention is applied.

FIG. 17a is a cross-sectional detailed view (before and after being pressed by the substrate) of the waterproofing means portion according to an embodiment of the present invention.

FIG. 17(b, c) is a combination diagram (cross-sectional view, cross-sectional detail) of the front body, waterproofing means, and substrate according to an embodiment of the present invention (sound wave inlet hole+waterproofing means).

FIG. 17 (d, e) is a front body, waterproof means portion and substrate combination diagram (cross-sectional view, cross-sectional detail view) according to an embodiment of the present invention (sound wave inlet hole+counter bore+waterproof means).

FIG. 17f is a diagram showing the combination of the front body, the waterproof means, and the substrate (a: Before being pressed by the substrate, b: After being pressed by the substrate) according to an embodiment of the present invention (sound wave inlet hole+counter bore+waterproof means).

FIG. 18 (a, b, c, d) is a rear configuration diagram (a: Before attaching the waterproof means, b: After attaching the waterproof means) of the front body according to one embodiment (sound wave inlet hole+counter bore+waterproof means).

FIG. 19 is an explanatory diagram of an acoustic performance test method for an acoustic camera of the present invention.

FIG. 20 (a, b, c) is a graph of acoustic performance test results (a: SNR, b: MSL, c: BW) for Comparative Example (Expandable sound wave inlet hole, no waterproof membrane), Example 1 (with expandable acoustic wave inlet+waterproof membrane, no counter bore), and Example 2 (Expandable sound wave inlet hole+waterproof membrane+counter bore) of the present invention.

FIG. 21 is a scene diagram of a submersion performance test for an acoustic camera equipped with a waterproof means of the present invention.

FIG. 22 (a, b, c) is a water spray waterproof test method and results (spray scene, internal confirmation scene after the test, certified report) for an acoustic camera equipped with a waterproof means of the present invention.

### MODE FOR INVENTION

Hereinafter, an acoustic camera equipped with explosion-proof means according to an embodiment of the present invention will be described in detail with reference to the attached drawings.

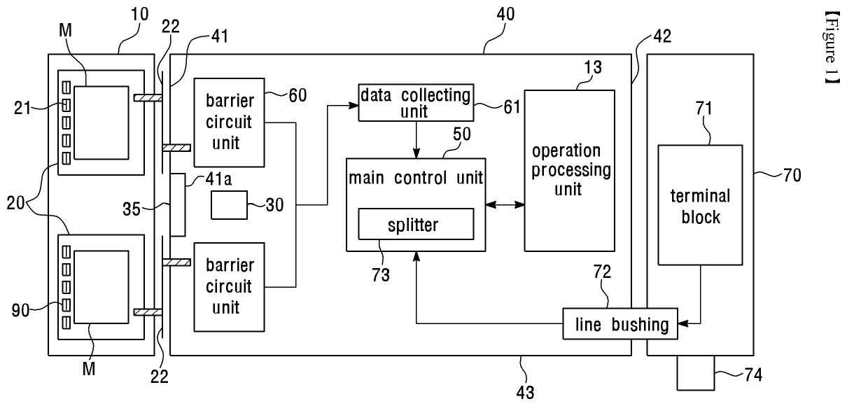

FIG. 1 is an overall configuration diagram of an acoustic camera equipped with an explosion-proof means or a waterproof means according to an embodiment of the present invention.

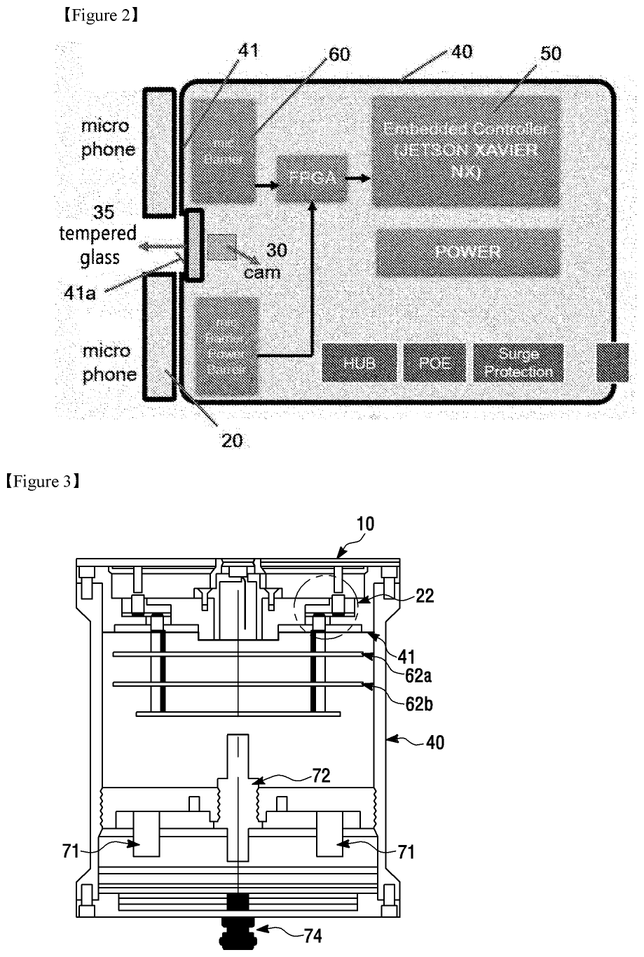

FIG. 2 is a partial configuration diagram of an acoustic camera equipped with explosion-proof means or waterproof means according to an embodiment of the present invention.

FIG. 3 is a cross-sectional view of an acoustic camera equipped with explosion-proof means according to an embodiment of the present invention.

As shown in FIGS. 1, 2, and 3, an acoustic camera equipped with an explosion-proof means or a waterproof means according to an embodiment of the present invention includes acoustic sensors (M) that detect sound waves flowing in through the acoustic wave guidance grooves 21, a sensor board 20 on which the acoustic sensors (M) are mounted, a photographing means 30 for taking an image of the scene toward which the sensor board 20 is facing, A housing 40 located at the rear of the sensor board 20 to form a built-in space (Room) and embedding the main control unit 50 and the operation processing unit 13 in the formed built-in space (Room), a main control unit 50 that receives and processes acoustic signals (e.g., PDM signals, Pulse Density Module) generated from acoustic sensors M.

As shown in FIG. 1, the sound wave inlet hole 11 may be configured in an expanded shape in which the width (or diameter) of the outer exposed portion is wider than the width (or diameter) of the adjacent portion of the sensor board 20.

The acoustic wave guidance groove 21 is composed of a groove dug in the sensor board 20 and the acoustic sensor M attached to the rear end of the sensor board 20.

The acoustic camera equipped with explosion-proof or waterproof means according to an embodiment of the present invention further includes a data collecting unit (FPGA, 61) between the sensor board 20 and the main control unit 50.

The barrier circuit unit 60 is provided between the sensor board 20 and the data collecting unit (FPGA, 61). The operation processing unit 13 placed in the built-in space (Room) of the housing 40 is connected to the main control unit 50.

The sensor board 20 and the barrier circuit unit 60 are connected to each other by a molding connector 22.

An acoustic camera equipped with explosion-proof or waterproof means according to an embodiment of the present invention includes a housing 40 and a terminal unit 70 connected to the front body 10 by a molding connector 22.

The terminal unit 70 includes a terminal block 71, a line bushing 72, and a cable connector 74.

A line bushing 72 is connected to a splitter 73 located in the main control unit 50.

The data collecting unit 61 collects acoustic (sound wave or ultrasonic wave) signals detected by the acoustic sensors M through the sensor board 20.

### Main Control Unit and Data Collecting Unit

The main control unit 50 calculates at least one acoustic parameter (e.g., beam power level at a point on a virtual plane) required for sound field visualization based on the acoustic signal from the data collecting unit 61.

The main control unit 50 performs beam forming.

In addition, the main control unit 50 converts the generated sound parameters into color images. Then, the main control unit 50 creates a photo-acoustic superimposed image by superimposing the optical image generated through the photographing means 30 and the acoustic color image generated by acoustic signal calculation.

As shown in FIGS. 1, 2, and 3, the data collecting unit 61 and the main control unit 50 are placed in the space (built-in room) formed by the housing 40.

Here, among the frequency bands analyzed (beam forming and sound field visualization) by the main control unit 50, at least some frequencies fall within the range of 200 Hz to 100 KHz.

More specifically, among the frequency bands analyzed and processed by the operation processing unit 13 of the acoustic camera based on the acoustic (sound wave or ultrasonic) signal detected by the acoustic sensors M, it is desirable that at least some frequencies fall within the range of 10 KHz to 30 KHz.

For example, in one embodiment, if the analysis possible range is 1 KHz to 15 KHz, at least a portion of “10 KHz to 15 KHz” falls within the “frequency: 10 KHz to 30 KHz range”, which is the range of the present invention, and is therefore included in the scope of the present invention.

Additionally, in another embodiment, when the analysis possible range is 25 KHz to 50 KHz, at least a portion of “25 KHz to 30 KHz” falls within the “frequency: 10 KHz to 30 KHz range”, which is the range of the present invention, and is therefore included in the scope of the present invention.

### Barrier Circuit Unit

As shown in FIGS. 1, 2, and 3, the acoustic camera equipped with explosion-proof means according to an embodiment of the present invention further includes a barrier circuit unit 60 installed between the acoustic sensors M and the main control unit 50.

The barrier circuit unit 60 suppresses an increase in current and voltage on the acoustic signal transmission line (e.g., PDM signal) and the clock signal from the acoustic sensor M.

The barrier circuit unit 60 transmits the acoustic signal generated by the acoustic sensor M to the main control unit 50.

The barrier circuit unit 60 and the main control unit 50 are located in the built-in space (Room) of the housing 40. The clock signal proceeds from the data collecting unit (FPGA, 61) toward the acoustic sensor (M).

An acoustic signal (e.g., a PDM signal) is transmitted from the acoustic sensor M to the data collecting unit (FPGA, 61).

Intrinsically safe explosion-proof structure is an explosion-proof structure that limits electrical energy so that it does not ignite in a hazardous atmosphere due to electric sparks, arcs, or high temperatures generated during normal or malfunction.

Intrinsically safe explosion-proof structures are characterized by being designed in consideration of the failure conditions of the device.

If the explosion-proof camera is configured only as explosion-proof, there is a problem in that sound is not transmitted to the acoustic sensor.

To solve this problem, it can be configured as intrinsically safe explosion proof.

In order to connect the acoustic sensor M and the data collecting unit (FPGA, 61) by a circuit, the barrier circuit unit 60 is located between the acoustic sensor M and the data collecting unit (FPGA, 61).

The barrier circuit unit 60 passes normal low energy signals, and passes signals with abnormal high-energy levels by limiting them to within the allowable level of the hazardous area.

According to one embodiment of the present invention, the voltage is limited using double or triple Zener diodes 60c constituting the barrier circuit unit 60. A resistance 60a is used to limit the current, and a fuse 60b is used to block abnormal power that is difficult for the Zener diode 60c to handle.

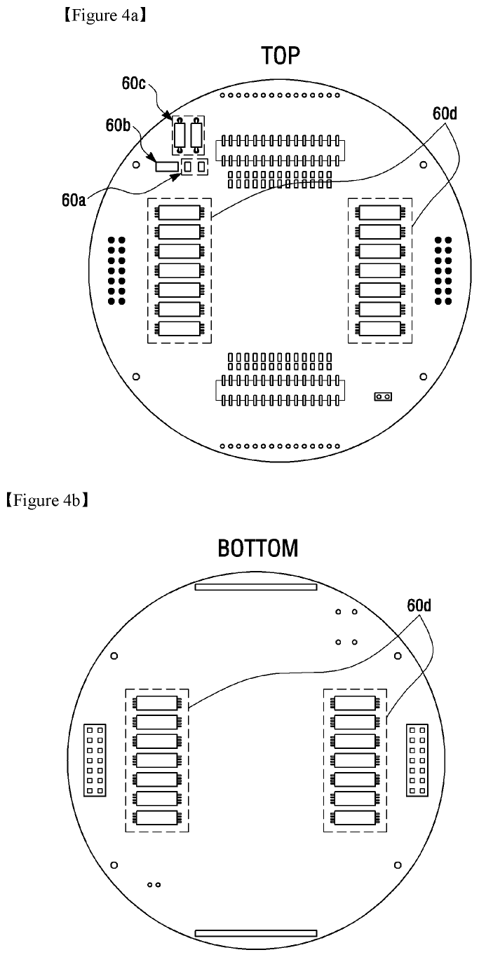

FIG. 4a is a plan view of the first barrier PCB area of the barrier circuit unit according to an embodiment of the present invention.

FIG. 4b is a bottom view of the first barrier PCB area of the barrier circuit unit according to an embodiment of the present invention.

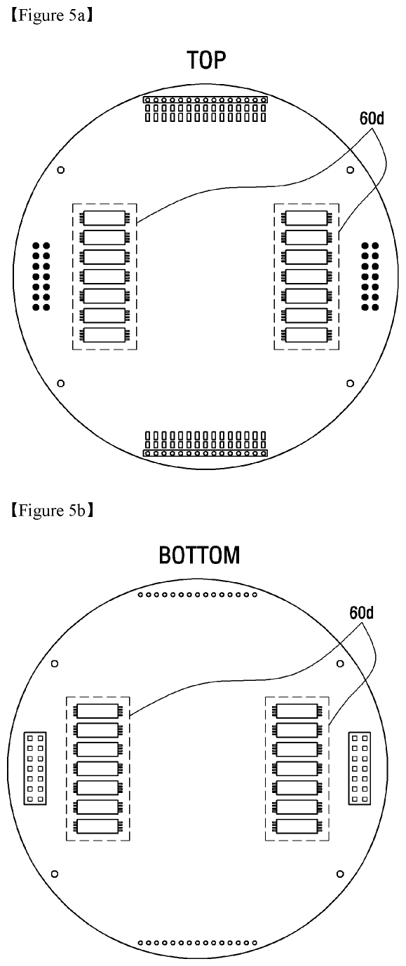

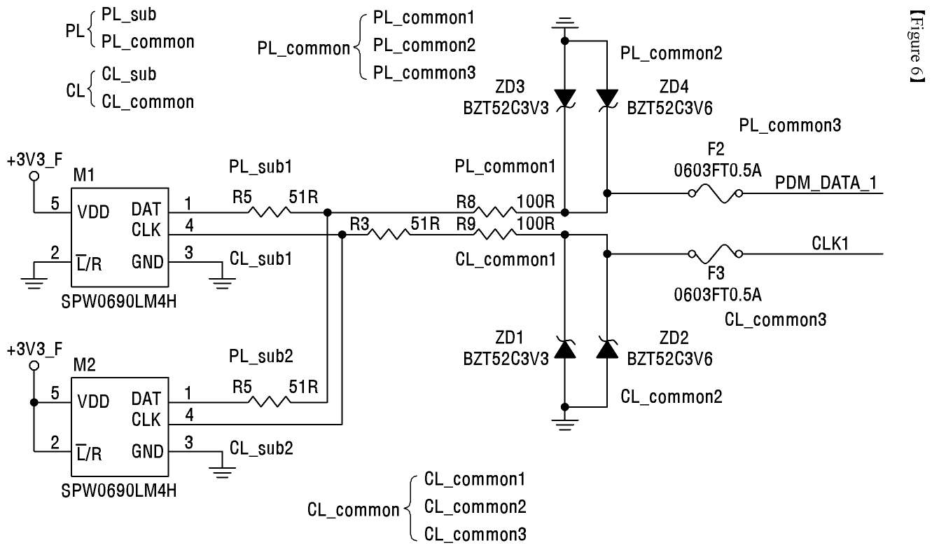

FIG. 5a is a plan view of the second barrier PCB area of the barrier circuit unit according to an embodiment of the present invention.

FIG. 5b is a bottom view of the second barrier PCB area of the barrier circuit unit according to an embodiment of the present invention.

As shown in FIGS. 4A and 5, the barrier circuit unit 60 includes a resistance 60a to suppress an increase in current on the acoustic signal transmission line PL that transmits an acoustic signal (PDM, pulse density module signal) generated by an acoustic sensor M or a clock signal transmission line CL that transmits a clock CLK signal phase, a Zener diode 60c to suppress a voltage rise, and a fuse M60b to block overcurrent.

According to one embodiment of the present invention, the barrier PCB area of the barrier circuit unit includes a first PCB area and a second PCB area.

The first PCB area includes a resistance 60a, a Zener diode 60c, a fuse 60b, and an opto-coupler 60d. The second PCB area includes an opto-coupler 60d.

FIG. 6 is a detailed diagram of a barrier circuit according to an embodiment of the present invention.

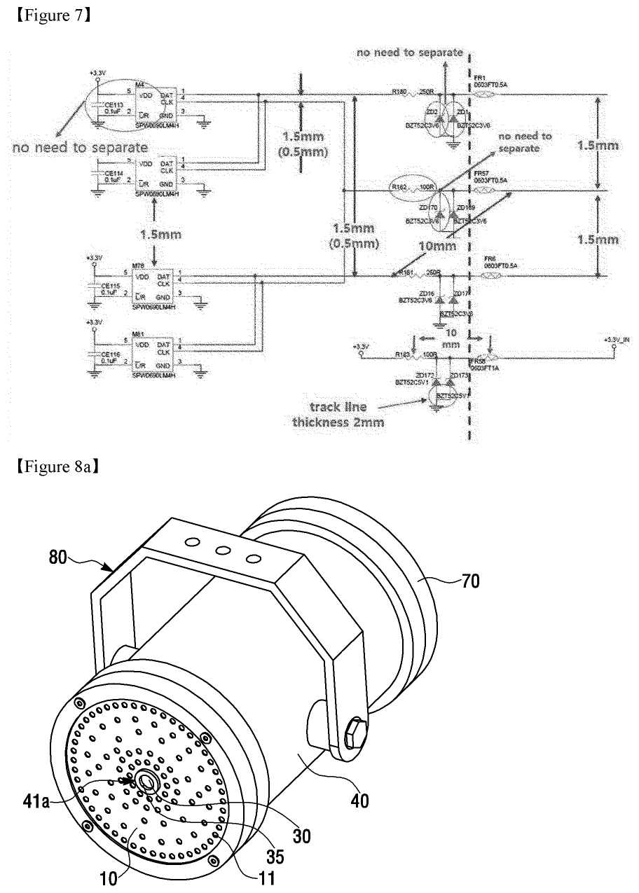

FIG. 7 is a detailed view of the separation distance of the barrier circuit unit according to an embodiment of the present invention.

As shown in FIG. 6, the first microphone (M1) of the barrier circuit unit 60 is connected to the acoustic signal common transmission line (PL_common) via the first acoustic signal transmission line (PL_sub1). The second microphone (M2) is connected to the acoustic signal common transmission line (PL_common) via the second acoustic signal transmission line (PL_sub2).

The first microphone (M1) is connected to the acoustic signal common transmission line (CL_common) via the first clock signal transmission line (CL_sub1). The second microphone (M2) is connected to the clock signal common transmission line (CL_common) via the second clock signal transmission line (CL_sub2).

As shown in FIG. 6, the acoustic signal common transmission line (PL_common) includes resistance installation part (PL_Common 1) where a resistor (resistance, 60a) is installed to suppress current rise, electronic devices to suppress voltage rise (e.g., Zener diode (60c), PL_common 2), and a fuse installation part (PL_common 3) in which a fuse 60b for blocking overcurrent is installed.

The clock signal common transmission line (CL_common) includes resistance installation section (CL_Common 1) where resistance (60a) is installed, Zener diode installation section (CL_common 2) where Zener diode (60c) is installed, and a fuse installation section (CL_common 3) where a fuse (60b) is installed.

Additionally, one resistance 60a may be installed on each of the acoustic signal transmission line (PL_sub1) and the second acoustic signal transmission line (PL_sub2).

Two Zener diodes 60c are installed in the Zener diode installation part (PL_common_2).

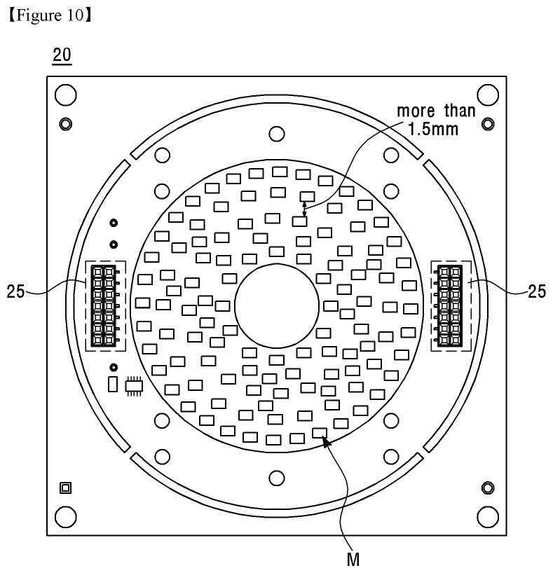

FIG. 7 is a detailed view of the separation distance of the barrier circuit unit according to an embodiment of the present invention. FIG. 10 is a detailed view of a substrate for a sensor according to an embodiment of the present invention.

As shown in FIGS. 7 and 10, the acoustic sensors M mounted on the sensor board 20 are preferably arranged to have a separation distance of 1.5 mm or more (exceeding) from each other.

It is possible to prevent the accumulation of electrical energy that increases the risk of overheating and explosion due to mutual proximity of acoustic sensors M below 1.5 mm.

As shown in FIG. 7, the distance between the sound signal transmission line (PL) and the clock signal transmission line (CL) is 1.5 mm or more. The separation distance between one acoustic signal common transmission line (PL_common) and the other acoustic signal common transmission line (CL_common) is preferably 1.5 mm or more.

At less than 1.5 mm, it is possible to prevent the accumulation of electrical energy that increases the risk of overheating and explosion of the board due to proximity to circuit lines.

According to one embodiment of the present invention, it is preferable that the separation distance between one fuse 60b and the other fuse 60b is 10 mm or more.

It is possible to prevent the accumulation of electrical energy that increases the risk of overheating and explosion due to the proximity of fuses 60b below 10 mm.

In one embodiment of the present invention, the power of the acoustic sensors M is 3.3 V.

Test results showed that even if the power of the acoustic sensors (M) was extended to the 1 to 5V range, the numerical limit was effective from an explosion-proof perspective.

It was found that within the numerical range, the risk of explosion of the acoustic camera was significantly reduced in high-explosive environments such as hydrogen gas.

### Molded Connector

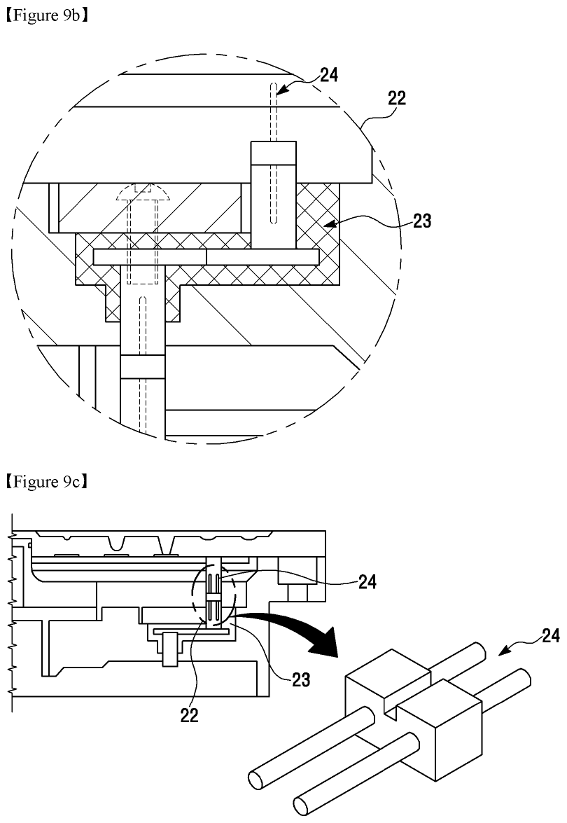

FIG. 9a is a cross-sectional view of epoxy molding according to an embodiment of the present invention.

FIG. 9b is a detailed cross-sectional view of epoxy molding according to an embodiment of the present invention.

FIG. 9c is a detailed cross-sectional view showing the pin header configuration of epoxy molding according to an embodiment of the present invention.

FIG. 10 is a detailed view of a substrate for a sensor according to an embodiment of the present invention.

As shown in FIGS. 1, 9A, 9B, and 9C, a molding connector 22 connects the housing 40 and the front body 10.

The molding connector 22 is coated with epoxy coating 23 and has excellent electrical insulation safety, high thermal conductivity, and low expansion coefficient.

In addition, due to the high moisture resistance due to the epoxy coating 23, it absorbs a very small amount of water and is excellent in waterproofing.

As shown in FIGS. 9C and 10, the molding connector 22 includes a pin header 24.

A pin header 24 is inserted into the pin header insertion portion 25 located on both sides of the sensor board 20.

### Quantity

FIG. 4a is a plan view of the first barrier PCB area of the barrier circuit unit according to an embodiment of the present invention.

FIG. 6 is a detailed diagram of a barrier circuit according to an embodiment of the present invention.

FIG. 10 is a detailed view of a substrate for a sensor according to an embodiment of the present invention.

As shown in FIGS. 6 and 10, 10 to 300 (N) acoustic sensors M may be provided.

For example, when 112 (N) acoustic sensors M are used and form a 2 Ch common line as shown in FIG. 6, there are 56 (N/2) acoustic signal common transmission lines (CL_common) and clock signal common transmission lines (CL_common) each.

At this time, as shown in FIGS. 4A and 6, 56 (N/2) fuses 60b and 60a resistors are provided on the acoustic signal common transmission line (PL_common).

When using a pair of Zener diodes 60c at one point, 56 (N/2) pairs of Zener diodes 60c are provided on the acoustic signal common transmission line.

The same principle applies to the clock signal common transmission line (CL_common).

### Housing Bulkhead Part

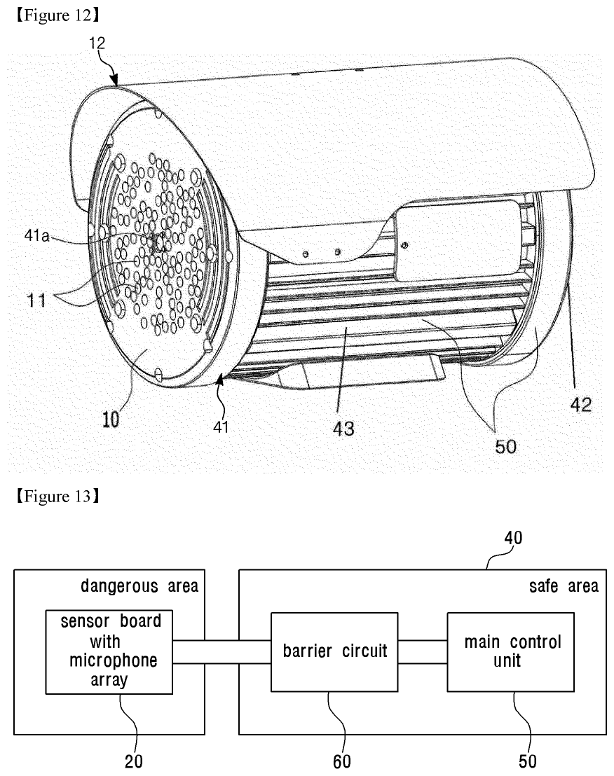

FIG. 12 is an external view of an acoustic camera equipped with an explosion-proof means or a waterproof means according to an embodiment of the present invention.

As shown in FIGS. 1, 2, 3, and 12, In the acoustic camera equipped with explosion-proof or waterproof means according to an embodiment of the present invention, the housing 40 includes a front partition 41 located behind the sensor board 20.

The housing 40 includes a rear wall part 42, a side wall 43, and a front partition 41 that form a built-in space (Room) blocked from the outside.

The sensor board 20 on which the acoustic sensor M is mounted is located in front of the front partition 41 outside the housing 40 (outside the built-in space).

The front partition 41 has an imaging hole 41a.

The imaging hole 41a is closed with transparent tempered glass 35.

The photographing means 30 is located behind the tempered glass 35 and in the built-in space (Room) of the housing 40.

The housing partition walls 41, 42, and 43 are characterized by having a pressure-resistant explosion-proof structure.

The pressure explosion-proof structure does not cause ignition even if an explosion occurs inside the housing 40.

Therefore, high-voltage equipment such as a data collecting unit (FPGA, 61), a main control unit 50, and a splitter 73 are built into the explosion-proof case.

The photographing means 30 is also located inside the housing 40 and is designed as a pressure-resistant explosion-proof structure, so even if the photographing means 30 explodes, it does not ignite.

Many cables with a pressure explosion-proof structure are characterized by thread processing and molding processing.

A molding connector 22 connects the sensor board 20 and the housing 40.

One end of the molding connector 22 facing the acoustic sensor M of the front body 10 is located on the radial outer side with respect to the central axis. The other end of the molding connector 22 facing the barrier circuit unit 60 is located on the inner side in the radial direction with respect to the central axis.

The interior of the molding connector 22 is an example of a pressure-resistant explosion-proof structure and is characterized by having an epoxy molding structure in response to explosion.

The epoxy molding structure serves to prevent explosive residues from leaking out.

Pressure-resistant explosion-proof structure refers to a structure designed so that the container can withstand explosion pressure and prevent the explosion flame from spreading outside the container.

A pressure-resistant explosion-proof structure is an explosion-proof structure that recognizes an explosion inside the container and recognizes an ignition source inside the container.

The standard for device temperature grade (T) refers to the surface temperature outside the container, and changes in the shape, arrangement, and volume of the device's internal parts can affect the explosion pressure.

Variations in heat generation depending on the electrical rating of the device's internal components can affect the device's temperature rating.

It is desirable to prevent the internal parts of devices in pressure explosion-proof containers from being arbitrarily replaced or altered.

### Front Body

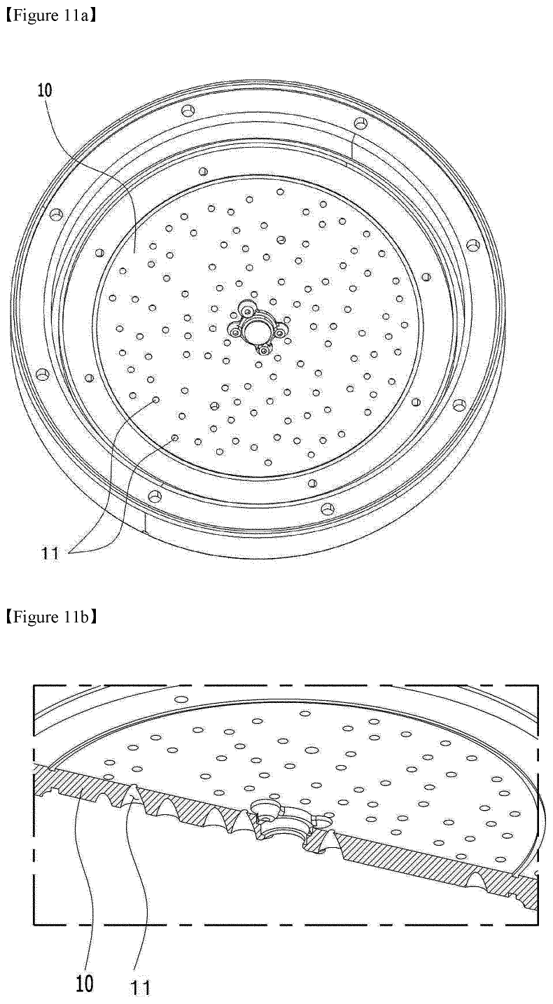

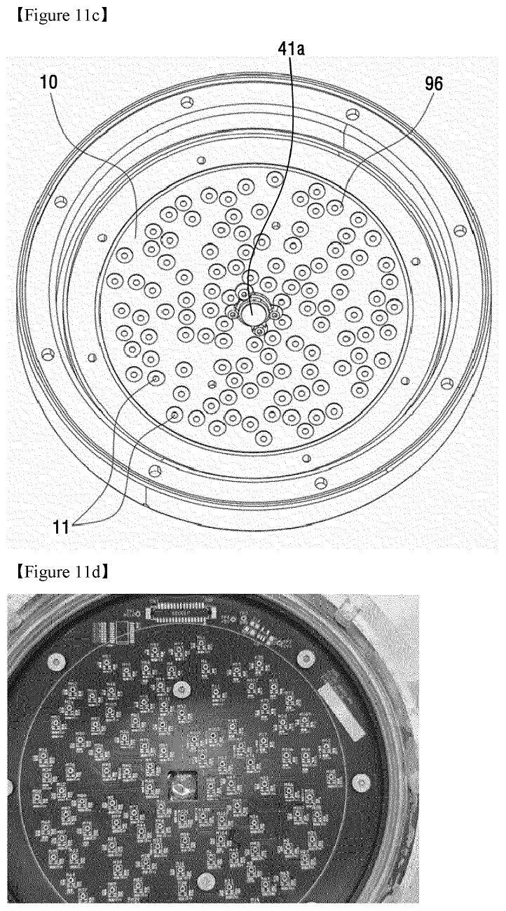

FIG. 11(a, b) is a detailed view of the front body according to one embodiment of the present invention.

FIG. 12 is an external view of an acoustic camera equipped with explosion-proof means according to an embodiment of the present invention.

As shown in FIGS. 11A and 111B, an acoustic camera equipped with an explosion-proof means or a waterproof means according to an embodiment of the present invention is preferably configured to further include a front body 10 provided with a plurality of sound wave inflow holes 11 that guide sound waves or ultrasonic waves to reach the acoustic sensor M.

As shown, in the sound wave inlet holes 11, the width (or diameter) of the outer exposed portion may be the same as the width (or diameter) of the adjacent portion of the sensor.

Alternatively, it may be configured as an expanded shape with a cross-sectional area that increases from the adjacent part of the sensor to the outer exposed part.

The front body 10 is made of plastic or metal, and can be produced by injection molding, etc., and then form the sound wave inlet hole 11 by cutting, punching, or processing. As shown in FIGS. 11A and 12, either the horizontal or vertical size of the front body 10 is in the range of 5.0 to 50 cm.

For heights greater than 50 cm, it is inappropriate to configure a portable acoustic camera.

In the case of 5 cm or less, there is a problem in that the number and separation distance of acoustic sensors are limited.

Therefore, a range of 5.0 to 50 cm is appropriate, and more preferably, a range of 7.5 to 35 cm is desirable from a movability point of view.

As shown in FIGS. 1, 11A, and 12, the front body 10 is made of plastic or metal and has a plane or curved shape that is convex toward the exposed side. There are 10 to 300 sound wave inlet holes 11 that penetrate the front body 10.

One sound wave inlet hole 11 of the front body 10 and one acoustic wave guidance groove 21 of the sensor board 20 are coupled to each other in communication with each other at corresponding positions.

Here, the number of sound wave inflow holes 11 is preferably 10 to 300, but if the number is less than 10, the separation distance between sensors on a board of the same size increases and the upper limit of the frequency at which the sound field can be visualized is limited.

If there are more than 300, there is a problem that the handling data throughput increases more than necessary, and the number of sensors in an actual 10˜20 cm acoustic (ultrasonic) camera is more than necessary, so installation problems arise when considering the separation distance between sensors.

10 to 300 is preferred, and 20 to 100 is more preferred for an acoustic or ultrasonic camera in the 5.0 to 50 cm range.

The plurality of acoustic sensors M are mounted integrally on the rigid or flexible sensor board 20, and the front body 10 and the sensor board 20 are integrally coupled. Accordingly, one acoustic sensor M is positioned correspondingly inside one sound wave inlet hole 11.

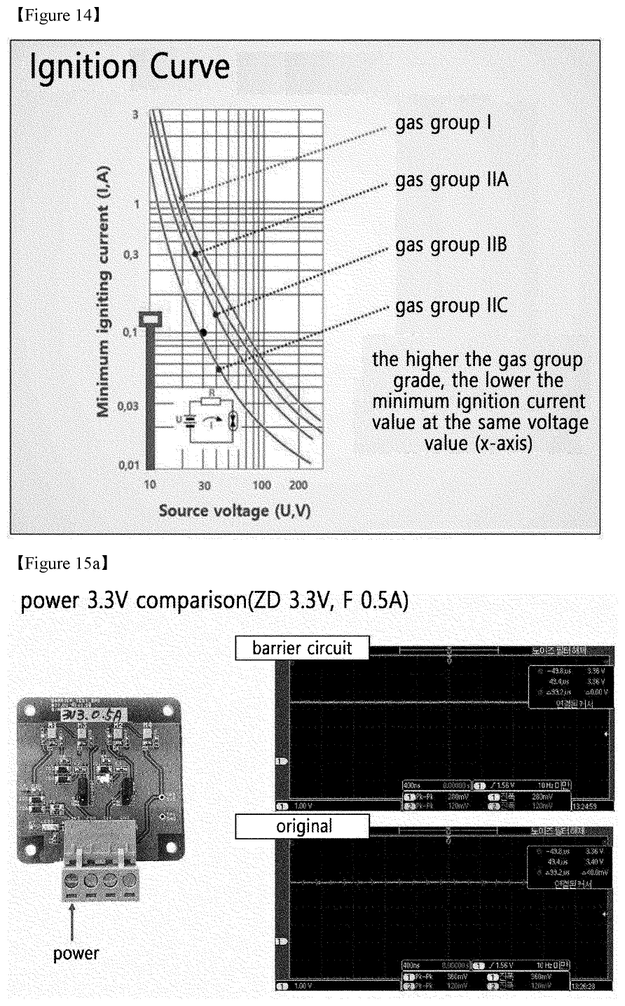

FIG. 14 is a gas ignition curve for explaining the effect of an acoustic camera equipped with explosion-proof means according to an embodiment of the present invention.

As shown in FIG. 14, when a current flows beyond the ignition curve, intrinsic safety cannot be achieved.

Acoustic cameras equipped with explosion-proof means target gas group IIC, and gas group IIC consists of gas vapor and acetylene hydrogen.

Acoustic cameras equipped with explosion-proof means operate at 10V or less, so they target gas group IIC, and intrinsic safety can be achieved when current flows up to 2 A. However, acoustic cameras equipped with explosion-proof means operate at 0.2 A or less at 10V or less, so intrinsic safety can be achieved.

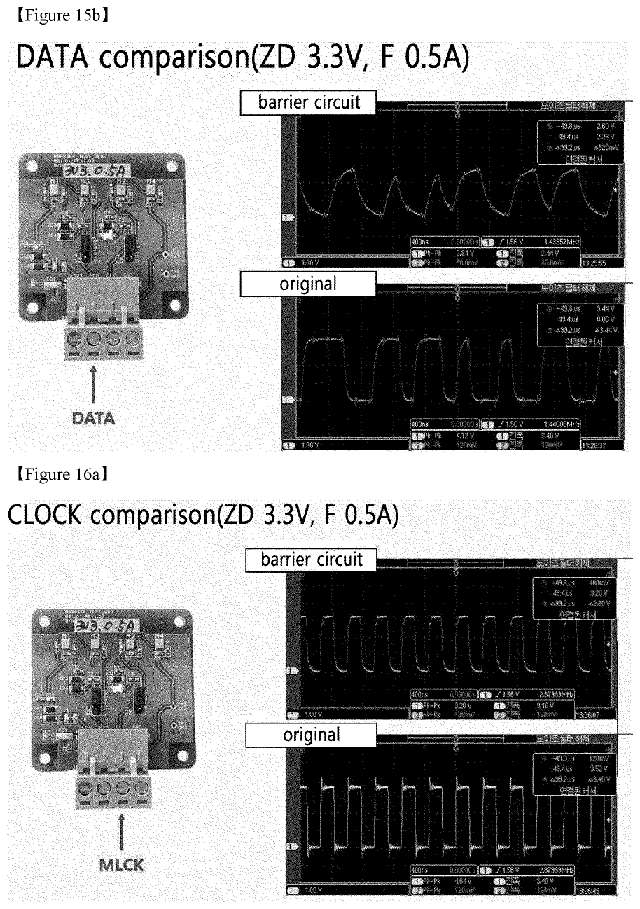

FIG. 15a is a performance result diagram (power waveform) of an acoustic camera to which the barrier circuit of FIG. 6 of the present invention is applied.

FIG. 15b is an acoustic camera performance result (PDM, acoustic signal waveform) to which the barrier circuit of FIG. 6 of the present invention is applied.

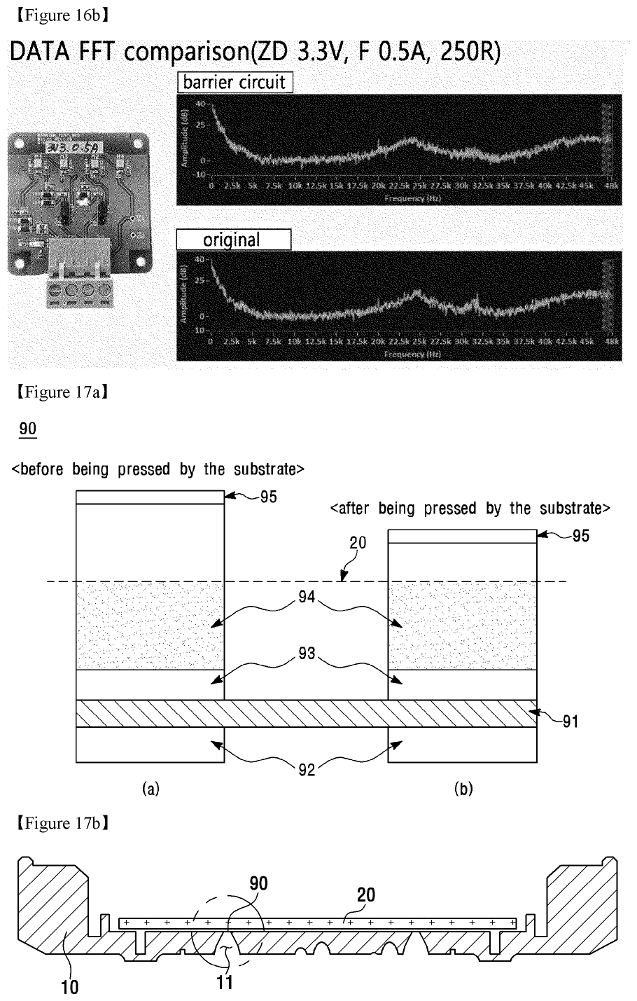

FIG. 16a is an acoustic camera performance result (clock signal waveform) to which the barrier circuit of FIG. 6 of the present invention is applied.

FIG. 16b is an acoustic camera performance result (acoustic signal FFT waveform) to which the barrier circuit of FIG. 6 of the present invention is applied.

As shown in FIGS. 15A, 15B, 16A, and 16B, the original result diagram shows the signal waveform when the barrier circuit does not exist.

The barrier circuit result diagram shows the signal waveform when the barrier circuit unit 60 is applied.

It can be seen that there is no significant difference between the signal waveform of the original result diagram and the signal waveform of the barrier circuit result diagram.

In other words, the test results showed that the data analysis performance (sound field visualization performance, sound wave and ultrasonic band) did not change compared to before the barrier circuit.

### Terminal Part

Increased safety refers to a structure that increases safety against mechanical, electrical, and temperature rises to prevent the occurrence of electric sparks, arcs, or high-temperature parts.

Increased safety does not recognize ignition sources and prevents ignition from occurring.

In addition, it plays a role in monitoring temperature rises (e.g., overload) and serves to strengthen insulation performance.

The temperature grade is based on the maximum surface temperature inside and outside the container, the rated load when starting the device, overload, and the temperature limit of the insulated winding.

FIG. 3 is a cross-sectional view of an acoustic camera equipped with an explosion-proof means or a waterproof means according to an embodiment of the present invention.

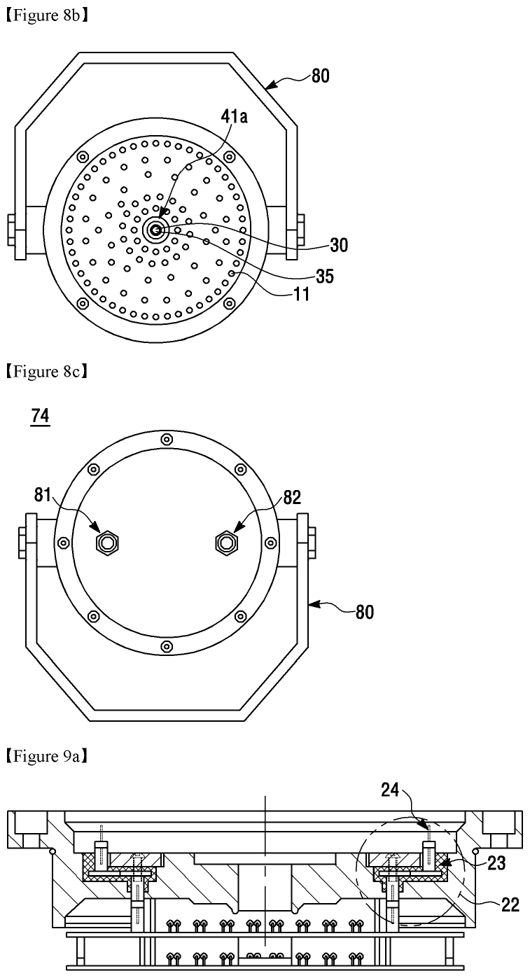

FIG. 8c is an external rear view of an acoustic camera equipped with an explosion-proof means or a waterproof means according to an embodiment of the present invention.

As shown in FIGS. 3 and 8C, the cable connector 74 of the terminal portion includes a system connector 81 and a heater power connector 82.

The terminal unit plays the role of increased safety, and for this purpose, the terminal block 71 satisfies the standards for increased safety.

Additionally, the terminal block 71 serves to prevent the high-voltage cable forming the explosion-proof structure from being exposed to the outside.

In addition, in order to perform the role of increased safety, the terminal unit 70 is characterized by a long distance between components.

### Waterproofing Means/Unit

FIG. 1 is an overall configuration diagram of an acoustic camera equipped with an explosion-proof means or a waterproof means according to an embodiment of the present invention.

FIG. 12 is an external view of an acoustic camera equipped with an explosion-proof means or a waterproof means according to an embodiment of the present invention.

As shown in FIGS. 1 and 12, an acoustic camera equipped with a waterproof means according to an embodiment of the present invention includes a front body 10, a sound wave inlet hole 11, a sensor board 20, a photographing means 30, a housing 40, and a waterproof means unit 90.

In addition, it may further include an upper protruding cover part 12 that is fixed to the upper part of the front body 10 or the housing 40 and protrudes further forward than the front of the front body 10.

According to one embodiment of the present invention, the front body 10 is provided with a plurality of sound wave inflow holes 11 that guide sound waves or ultrasonic waves to reach the acoustic sensor M.

The acoustic sensor M detects sound waves flowing in through the sound wave inlet hole 11 of the front body 10 while being fixed to the sensor board 20.

Acoustic sensors (M) are mounted on the sensor board 20.

The photographing means 30 photographs the scene toward which the front body 10 is facing.

In one embodiment of the present invention, the photographing means 30 includes an optical lens for imaging. The optical lens is optically exposed toward the front through the imaging hole 41a located in the center of the front body 10 to capture images.

According to one embodiment of the present invention, the housing 40 covers the sensor board 20 and the rear of the front body 10, with the sensor board 20 located on the rear side of the front body 10.

The waterproof means unit 90 blocks water from reaching the acoustic sensor M or the sensor board 20 through the sound wave inlet hole 11.

As shown in FIG. 12, the housing 40 may have a hollow cylindrical shape forming the body.

According to one embodiment of the present invention, the data collecting unit 61 and the operation processing unit 13 are placed in the built-in space (Room) formed by the front body 10 and the housing 40.

Here, among the frequency bands analyzed and processed by the operation processing unit 13, at least some frequencies fall within the range of 200 Hz to 100 KHz.

More specifically, among the frequency bands analyzed and processed by the operation processing unit 13 of the acoustic camera based on the acoustic (sound wave or ultrasonic) signal detected by the acoustic sensor M, it is preferable that at least some frequencies fall within the 10 KHz˜30 KHz range.

For example, in one embodiment, when the analyzable range is 1 KHz to 15 KHz, at least part of “10 KHz to 15 KHz” falls within the “frequency: 10 KHz to 30 KHz range”, which is the range of the present invention, and is therefore included in the scope of the present invention.

In addition, in another embodiment, when the analyzable range is 25 KHz to 50 KHz, at least part of “25 KHz to 30 KHz” falls within the “frequency: 10 KHz to 30 KHz range”, which is the range of the present invention, and is therefore included in the scope of the present invention.

FIG. 11 (a, b, c) is a detailed view of the front body according to an embodiment of the present invention.

As shown in FIGS. 11a to 11c, the width or diameter of the front side (exposed side) of the sound wave inlet hole 11 is larger than the width or diameter of the rear side (substrate side). In addition, it includes an expanded shape in which the cross-sectional area is continuously widened from the rear side (substrate side) to the front side (exposed side).

According to one embodiment of the present invention, the sound wave inlet holes 11 may be configured so that the width (or diameter) of the outer exposed portion is the same as the width (or diameter) of the adjacent portion of the sensor.

Alternatively, it includes an expanded shape in which the cross-sectional area increases from the adjacent part of the sensor to the outer exposed part.

The front body 10 is made of plastic or metal and can be produced by injection molding or the like, and then form the sound wave inlet hole 11 by cutting or punching.

According to one embodiment of the present invention, either the horizontal or vertical size of the front body 10 is in the range of 5.0 to 50 cm.

For heights greater than 50 cm, it is inappropriate to configure a portable acoustic camera.

In the case of 5 cm or less, there is a problem in that the number and separation distance of acoustic sensors are limited.

Therefore, a range of 5.0 to 50 cm is appropriate, and more preferably, a range of 7.5 to 35 cm is desirable from a movability point of view.

FIG. 11(a, b) is a detailed view of the front body according to one embodiment of the present invention.

As shown in FIG. 11a, the front body 10 is made of plastic or metal and has a plane or curved shape convex toward the exposed side. There are 10 to 300 sound wave inlet holes 11 penetrating the front body 10, and one acoustic sensor (M) is disposed in one sound wave inlet holes 11.

Here, the number of sound wave inflow holes 11 is preferably 10 to 300, but if the number is less than 10, the separation distance between sensors on a board of the same size increases and the upper limit of the frequency at which the sound field can be visualized is limited.

If there are more than 300, there is a problem that the handling data throughput increases more than necessary, and the number of sensors in an actual 10˜20 cm acoustic (ultrasonic) camera is more than necessary, so installation problems arise when considering the separation distance between sensors.

The number of sound wave inlet holes is preferably 10 to 300, and more preferably 20 to 100 for an acoustic or ultrasonic camera with a range of 5.0 to 50 cm.

FIG. 11d is a configuration diagram of the front body and substrate combination according to an embodiment of the present invention.

According to FIG. 11d, there is a state in which the sensor is mounted integrally on a rigid or flexible sensor board 20. At this time, the front body 10 and the sensor board 20 of the plurality of acoustic sensors M are integrally coupled by an assembly means. Accordingly, one acoustic sensor (M) is positioned correspondingly inside one sound wave inlet hole (11).

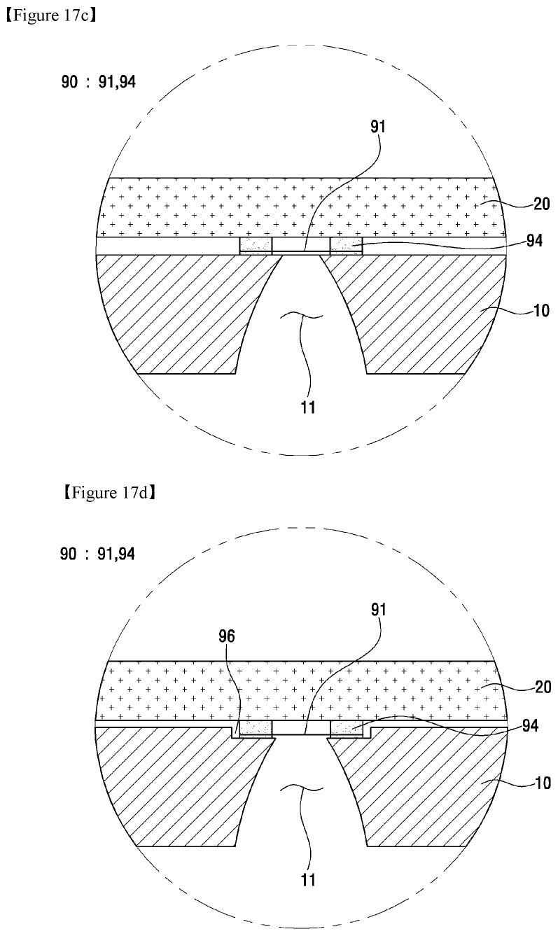

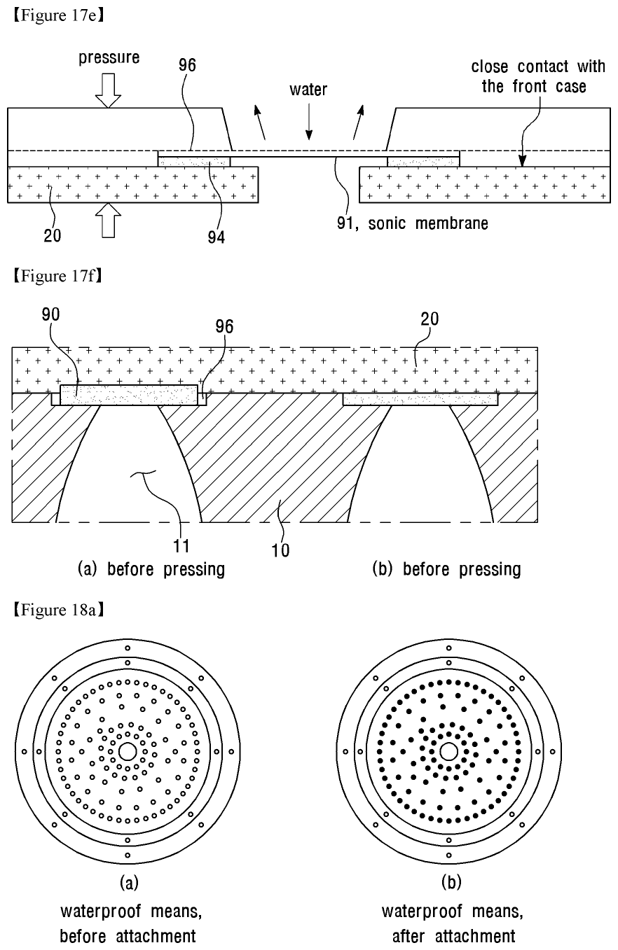

FIG. 17a is a detailed cross-sectional view (before and after being pressed by a substrate) of the waterproof means according to an embodiment of the present invention.

FIG. 17(b, c) is a combination diagram (cross-sectional view, cross-sectional detail) of the front body, waterproofing means, and substrate according to an embodiment of the present invention (sound wave inlet hole+waterproofing means).

FIG. 17 (d, e) is a front body, waterproof means portion and substrate connection diagram (cross-sectional view, cross-sectional detail view) according to an embodiment of the present invention (sound wave inlet hole+counter bore+waterproof means).

FIG. 17f is a diagram showing the combination (a: Before being pressed by the substrate, b: After being pressed by the substrate) of the front body, the waterproof means, and the substrate according to an embodiment of the present invention (sound wave inlet hole+counter bore+waterproof means).

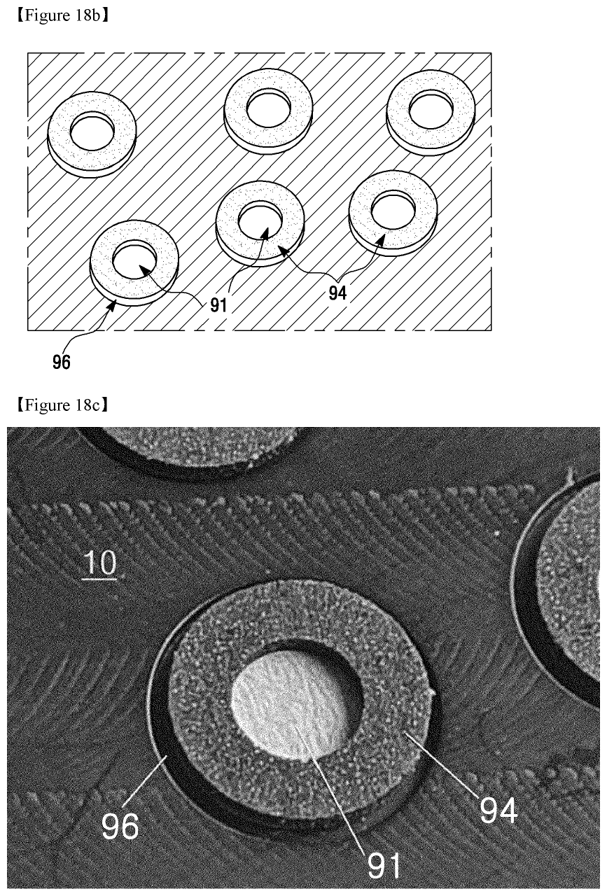

FIG. 18 (a, b) is a rear configuration diagram of the front body (a: before attaching the waterproof means, b: after attaching the waterproof means) according to one embodiment (sound wave inlet hole+counter bore+waterproof means).

As shown in FIGS. 17a to 17f and FIG. 18(a, b), the waterproof means unit 90 includes a sound wave-permeable waterproof membrane 91 that laterally shields the sound wave inlet hole 11 to prevent water from penetrating through the sound wave inlet hole 11.

Sound waves pass through the sound wave-permeable waterproof membrane 91 and are transmitted toward the substrate, but water does not penetrate the sound wave-permeable waterproof membrane 91.

The sound wave-permeable waterproof membrane 91 may be located on the front of the front body 10 or at the midpoint of the sound wave inlet hole 11 (a point between the front and rear ends of the sound wave inlet hole).

There are cases where the sound wave-permeable waterproof membrane 91 is located at an intermediate point (a point between the front end and the rear end of the sound wave inlet hole). At this time, the inner wall forming the sound wave inlet hole 11 may be manufactured separately and then assembled after inserting the sound wave-permeable waterproof membrane 91.

The acoustic sensors M attached to the sensor board 20 are positioned facing the sound wave inlet holes 11 and the waterproof means unit 90 at corresponding positions.

The waterproof means unit 90 may be composed of a sound wave-permeable waterproof membrane 91, a first adhesive layer 92, and a sponge layer 94.

The first adhesive layer 92 is located at the periphery and front side of the sound wave-permeable waterproof membrane 91 and comes into contact with the rear side of the front body 10.

At this time, the sponge layer 94 is attached to the rear peripheral portion (opposite the first adhesive layer) of the sound wave-permeable waterproof membrane 91. And it includes a material that is in contact with the front surface of the sensor board 20 and is pressed and compressible by the pressure of the sensor board 20.

As shown in FIG. 17a, the waterproof means unit 90 may be further provided with a second adhesive layer 95 attached to the front of the sensor board 20 on the rear side of the sponge layer 94 (opposite the first adhesive layer 92).

The sponge layer 94 is attached to the front surface of the sensor board 20 by the second adhesive layer 95. The thickness of the sound wave-permeable waterproof membrane 91 of the waterproof means unit 90 is preferably 0.005 to 0.02 mm.

If it is less than 0.005 mm, it is difficult to manufacture and waterproofness is weakened, and if it is more than 0.02 mm, waterproofness increases but sound wave permeability is poor.

The fabric of the sound wave-permeable waterproof membrane 91 was F69 MBR fabric ordered from Kolon Materials (Address: Kolon Tower, 11 Kolon-ro, Gwacheon-si, Gyeonggi-do, Korea). As shown in FIGS. 17D to 17F, the acoustic camera equipped with a waterproof means further has a counter bore 96 formed by being stepped from the rear of the front body 10.

The waterproof means unit 90 is placed in a counter bore 96.

The peripheral portion of the sound wave-permeable waterproof membrane 91 is attached to the bottom surface of the counter bore 96 by a first adhesive layer 92.

According to one embodiment of the present invention, the counter bore 96 may be a stepped groove or a flat cylindrical groove formed on the opposite side of the sound wave inlet hole 11 formed forward, that is, on the rear side of the front body 10 toward the front side.

A counter bore 96 communicates with the rear of the sound wave inlet hole 11.

The counter bore 96 provides a space in which the waterproof means unit 90 is placed and provides convenience in installing the waterproof means unit 90.

The step of the counter bore 96 prevents the waterproof means unit 90 from deviating laterally.

As shown in FIGS. 17a to 17f and FIG. 18 (a, b, c, d), before the sensor board 20 is combined with the front body 10 by assembly, the waterproof means unit 90 may be positioned in the counter bore 96. At this time, the sponge layer 94 protrudes rearward higher than the rear surface of the counter bore 96.

In such a state, as shown in FIG. 17f, the front of the sensor board 20 is combined with the front body 10 while pressing the sponge layer 94.

The depth of the counter bore 96 is preferably 0.2 to 2 mm. If the depth of the counter bore 96 is less than 0.2 mm, lateral deviation of the waterproof means unit 90 may occur. Therefore, when the depth of the counter bore 96 is more than 2 mm, there is a problem in that the size of the waterproof means unit 90 becomes larger than necessary.

In one embodiment of the present invention shown in FIG. 17A, the depth of the counter bore 96 is 0.45 mm, and the overall height of the waterproof means unit 90 including the sponge layer 94 is 0.66 mm.

The sponge layer 94 has restoring force while being pressed by 0.21 mm by the pressure of the sensor board 20.

Due to the restoring force of the sponge layer 94, the sponge layer 94 adheres the peripheral portion of the sound wave-transmitting waterproof membrane 91 to the bottom surface of the counter bore 96 or the rear surface of the front body 10.

As a result, separation and disengagement of the sound wave-permeable waterproof membrane 91 is prevented.

Additionally, a resilient pressurized sponge layer (94) presses against the rear periphery of the sound wave-permeable waterproof membrane 91. As a result, the inflow of water through the gap between the front periphery of the sound wave-permeable waterproof membrane 91 and the rear surface of the front body 10 (or the bottom surface of the counter bore 96) is blocked.

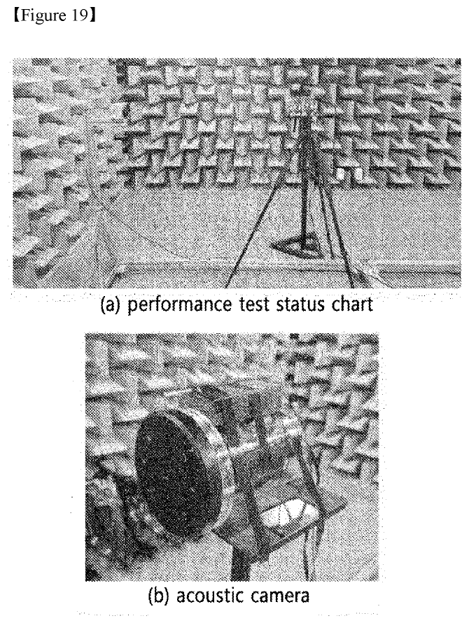

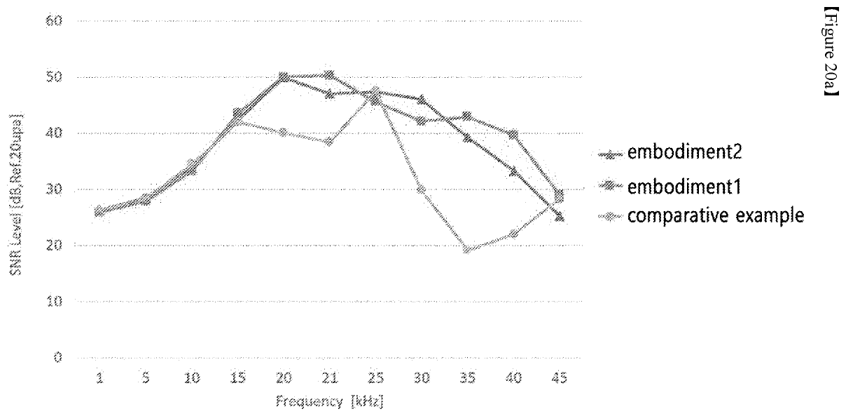

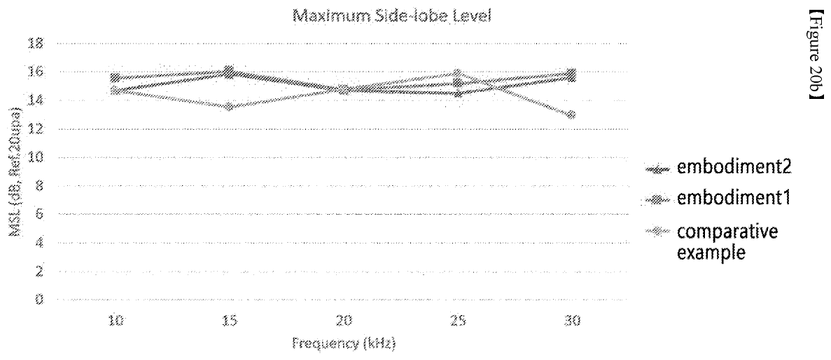

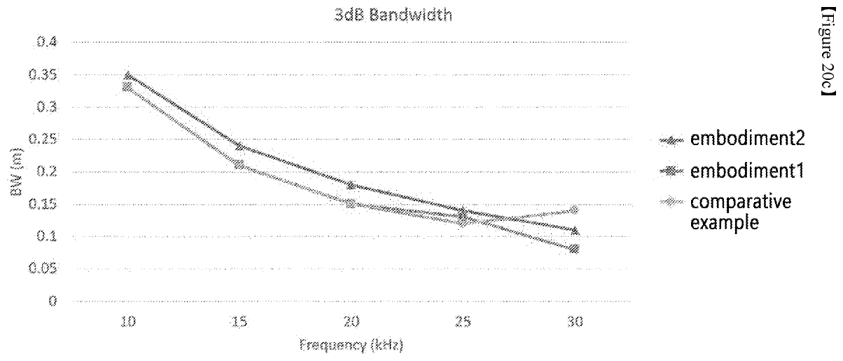

FIG. 19 is an explanatory diagram of an acoustic performance test method for an acoustic camera of the present invention.

FIG. 20 (a, b, c) is a graph (a: SNR, b: MSL, c: BW) of the acoustic performance test results for the comparative example of the present invention (expanded sound wave inlet hole, no waterproof membrane), Example 1 (expandable acoustic wave inlet hole+waterproof membrane, no counter bore), Example 2 (expandable acoustic wave inlet hole+waterproof membrane+counter bore).

In FIG. 20a, the signal-to-noise ratio (SNR) measurement result for each frequency is generally judged to have excellent performance if the sensor's signal-to-noise ratio is high, and a sensor or array with a higher SNR can measure even quieter sounds.

In FIG. 20a, in case of SNR performance, the acoustic camera equipped with a waterproof means according to an embodiment of the present invention shows the same overall array sensor performance as the existing acoustic camera without a waterproof means. In addition, it was confirmed that equivalent or higher performance was achieved in the region above 20 kHz.

In FIG. 20b, the maximum side lobe level measurement result by frequency (MSL): It is one of the representative performance indicators of an array sensor. The higher the MSL, the better the performance of simultaneously distinguishing noise sources of various sizes.

Generally, the higher the msl, the better the performance of the array sensor.

In FIG. 20c, 3 dB beam width performance measurement result for each frequency (3 dB bandwidth): It is one of the representative performance indicators of an array sensor, and performance is judged by calculating the beam width at a position that is −3 dB from the level of the maximum side lobe.

The smaller the beam width, the better the ability to distinguish multiple nearby noise sources, and generally, the smaller the 3 dB bandwidth, the better the performance of an array sensor.

In FIGS. 20b and 20c, it was confirmed that in terms of MSL and BW performance, there is no significant difference in performance between the acoustic camera equipped with a waterproofing means according to an embodiment of the present invention and the existing acoustic camera without a waterproofing means attached.

FIG. 21 is a scene diagram of a submersion performance test for an acoustic camera equipped with a waterproof means of the present invention.

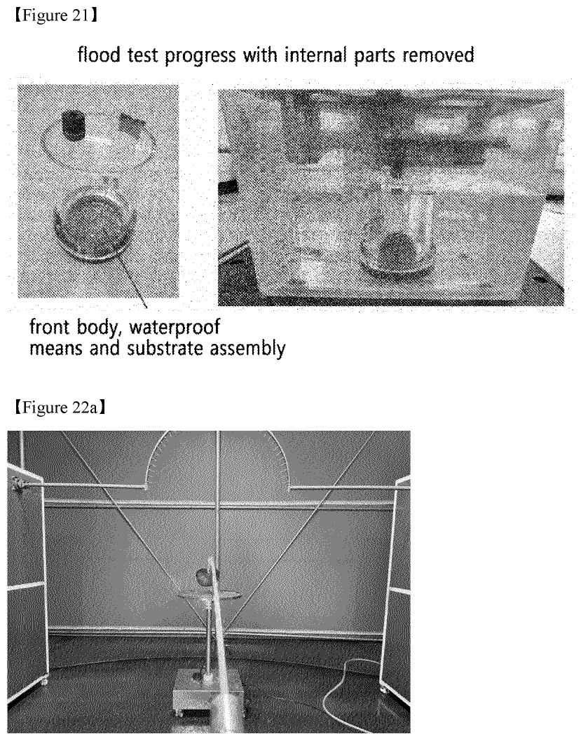

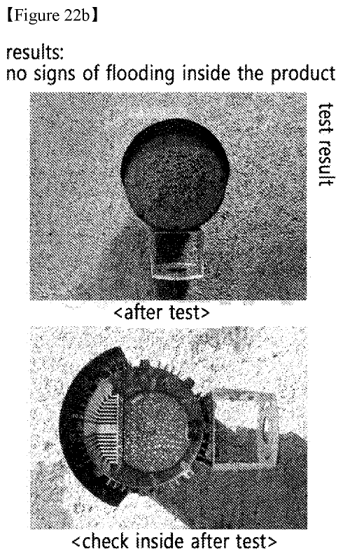

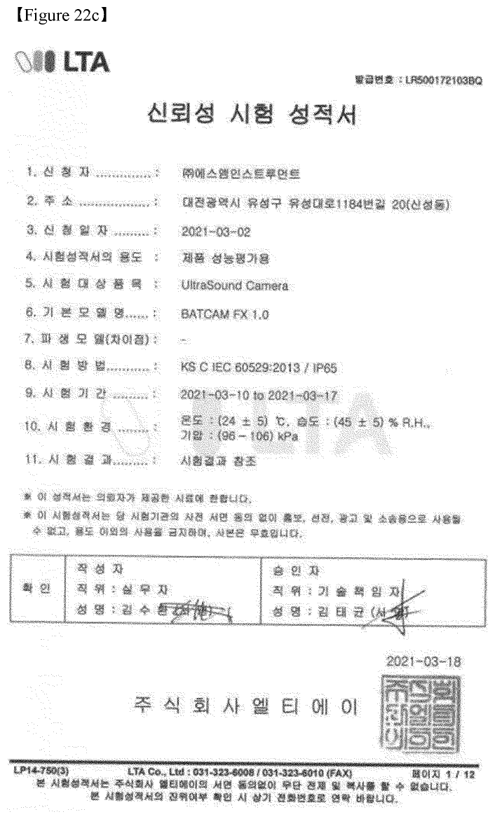

FIGS. 22a to 22c show the water spray waterproofing test method and results (spraying scene, internal confirmation scene after the test, certified report) for an acoustic camera equipped with a waterproofing means of the present invention.

As shown in FIG. 21, as a result of an immersion test on an acoustic camera equipped with a waterproof means of the present invention, it was confirmed that water did not penetrate into the sensor board 20.

As shown in FIGS. 22a to 22c, the water spray waterproofing test and results (spraying scene, internal confirmation scene after the test, certified report) for an acoustic camera equipped with the waterproofing means of the present invention are shown.

The water spray test conditions are as follows.
Protection against water spray
Test conditions
Nozzle inner diameter: 6.3 mm/Waterproof rate: 12.5 L/min±5%
Center of water flow: A circle of approximately 40 mm, 2.5 m away from the nozzle.
Distance from nozzle to enclosure surface: 2.5˜3 m Test time: 1 minute per 1 m2 of enclosure surface area, minimum test time is 3 minutes (test time: 3 minutes)

As shown in FIG. 22b, as a result of the water spray test, it was confirmed that water did not penetrate into the sensor board 20.

Although the invention has been described in connection with the above-mentioned preferred embodiments, the scope of the invention is not limited to these embodiments. The scope of the present invention is defined by the following patent claims and will include various modifications and variations within the scope of equivalents to the present invention.

The drawing symbols used in the patent claims below are merely intended to aid understanding of the invention and do not affect the interpretation of the scope of rights. The scope of rights should not be narrowly interpreted based on the drawing symbols.

### EXPLANATION OF SYMBOLS

10: front body
11: Sound wave inlet hole
M: Acoustic sensor
12: upper protruding cover part
13: Operation processing unit
20: Board for sensor
21: acoustic wave guidance groove
22: molded connector
23: Epoxy coating
24: Pin header
25: Pin header insertion portion
30: photographing means
35: tempered glass
40: housing
41a: imaging hole
42: rear wall part
43: side wall part
50: main control unit
60: barrier circuit unit
60a: resistance
60b: fuse
60c: Zener diode
60d: opto-coupler
61: data collecting unit
62a: first barrier PCB area
62b: second barrier PCB area
70: terminal unit
71: terminal block
72: Line bushing
73: splitter
74: cable connector
80: Installation bracket
81: system connector
82: heater power connector
90: waterproof means unit
91: acoustic transparent waterproof membrane
92: first adhesive layer
93: middle adhesive layer
94: sponge layer
95: second adhesive layer
96: counterbore

1. An acoustic camera equipped with explosion-proof means, the acoustic camera comprising:
acoustic sensors detecting sound wave or ultrasonic wave;
a sensor board on which the acoustic sensors are mounted;
a housing locating at the rear of the sensor board and forming a built-in space; and
a main control unit receiving and processing acoustic signals generated from the acoustic sensors,
wherein the main control unit is located in the built-in space, and
wherein the sensor board is located outside the housing.

2. The acoustic camera of claim 1, configured to further comprise a barrier circuit unit installed between the acoustic sensors and the main control unit, and
wherein the barrier circuit unit transmits the acoustic signal generated by the acoustic sensor to the main control unit,
wherein the barrier circuit unit suppresses an increase in current or voltage on an acoustic signal transmission line transmitting the acoustic signal generated by the acoustic sensor, and
wherein the barrier circuit unit and the main control unit are located in the built-in space of the housing.

3. The acoustic camera of claim 2, further equipped with a data collecting unit between the sensor board and the main control unit, and
wherein the barrier circuit unit is provided between the sensor board and the data collecting unit.

4. The acoustic camera of claim 1, further comprising a photographing means taking an image of the scene toward which the sensor board is facing.

5. The acoustic camera of claim 2,
wherein the barrier circuit unit comprises a resistance to suppress current rise, a Zener diode to suppress voltage rise, a fuse to block overcurrent on an acoustic signal transmission line that transmits the acoustic signal generated by the acoustic sensor or a clock signal transmission line that transmits a clock signal.

6. The acoustic camera of claim 5,
wherein the barrier circuit unit further comprises:
a first acoustic sensor is connected to the acoustic signal common transmission line via the first acoustic signal transmission line,
a second acoustic sensor is connected to the acoustic signal common transmission line via a second acoustic signal transmission line,
a first acoustic sensor is connected to the clock signal common transmission line via a first clock signal transmission line, and
a second acoustic sensor is connected to the clock signal common transmission line via a second clock signal transmission line.

7. The acoustic camera of claim 6,
wherein the acoustic signal common transmission is configured to further comprise,
a resistance installation part in which the resistor is installed to suppress current rise;
an electronic element installation part for suppressing voltage rise, where the Zener diode for suppressing voltage rise is installed, and
a fuse installation part where the fuse is installed to block overcurrent.

8. The acoustic camera of claim 6,
wherein the clock signal common transmission line is configured to comprise,
a resistor installation part where the resistor is installed,
an electronic element installation part for suppressing voltage rise, where the Zener diode for suppressing voltage rise is installed, and
a fuse installation part where the above fuse is installed.

9. The acoustic camera of claim 1,
wherein the acoustic sensors are disposed on the sensor board to have a separation distance of 1.5 mm or more from each other.

10. The acoustic camera of claim 5,
wherein a distance between the acoustic signal transmission line and the clock signal transmission line is 1.5 mm or more, and
wherein a separation distance between one acoustic signal common transmission line and the other acoustic signal common transmission line is 1.5 mm or more.

11. The acoustic camera equipped with explosion-proof of claim 5,
wherein the separation distance between one fuse and the other fuse among the plurality of fuses is 10 mm or more.

12. The acoustic camera of claim 5,
wherein the housing includes a rear wall, a side wall, and a front partition that form the built-in space blocked from the outside, and
wherein the sensor board is located in front of the front partition, outside the housing.

13. The acoustic camera of claim 1,
further comprising a front body provided with sound wave inflow holes that guide the sound wave or the ultrasonic wave to reach the acoustic sensor.

14. The acoustic camera of claim 12,
wherein the front partition has an imaging hole,
wherein the imaging hole is closed with transparent tempered glass, and
wherein the photographing means is located behind the tempered glass or in the built-in space of the housing.

15. An acoustic camera equipped with waterproof means, the acoustic camera comprising:
a front body equipped with sound wave inlet holes,
acoustic sensors detecting sound waves or ultrasonic waves flowing through the sound wave inlet holes;
a sensor board on which the acoustic sensors are mounted;
a photographing means for taking an image of the scene toward which the front body is facing;
a housing covering the rear of the front body; and
a waterproof means for preventing water from reaching the acoustic sensor or the sensor board through the sound wave inlet holes.

16. The acoustic camera of claim 15,
wherein the waterproof means comprise a sound wave-permeable waterproof membrane that laterally shields the sound wave inlet holes to prevent water from penetrating, and
wherein the location of the sound wave-permeable waterproof membrane is provided at the front of the front body, at a midpoint of the sound wave inlet holes (point between the front and rear ends of the sound wave inlet hole), or between the rear of the front body and the front of the sensor board.

17. The acoustic camera of claim 16,
wherein the sound wave inflow holes have a width or diameter on the front side (exposed side) that is larger than that on the back side (board side) and have an expanded shape in which the cross-sectional area continuously widens from the rear side (board side) to the front side (exposed side).

18. The acoustic camera of claim 17,
wherein the waterproof means comprises the sound wave-permeable waterproof membrane that laterally shields the sound wave inlet holes, a first adhesive layer located on the rear side of the front body or the front side of the sound wave-permeable waterproof membrane and a compressible sponge layer attached to the opposite side of the first adhesive layer and pressed in contact with the front surface of the sensor board.

19. The acoustic camera of claim 18,
wherein a stepped counter bore is further formed at the sound wave inlet holes from the rear of the front body,
wherein the waterproof means unit is placed in the counter bore, and
wherein the first adhesive layer is in contact with the bottom surface of the counter bore.

20. The acoustic camera of claim 16,
wherein the thickness of the sound wave-permeable waterproof membrane of the waterproof means is 0.005 to 0.02 mm.

21. The acoustic camera of claim 18,
wherein the waterproof means unit is located on the rear side of the sponge layer (opposite the first adhesive layer) and further comprises a second adhesive layer attached to the front of the sensor board.

22. The acoustic camera of claim 19,
wherein the counter bore has a depth of 0.2 to 2 mm.

23. The acoustic camera of claim 15, further comprising an upper protruding cover part fixed to the upper part of the front body or the housing and protruding further forward than the front of the front body.
